(19) United States
(12) Patent Application Publication
(10) Pub. No.: US 2022/0109142 A1
(43) Pub. Date: Apr. 7, 2022

(54) ELECTRODE STRUCTURES FOR LITHIUM BATTERIES

(71) Applicant: Global Graphene Group, Inc., Dayton, OH (US)

(72) Inventors: Hui He, Dayton, OH (US); Bor Z. Jang, Centerville, OH (US)

(21) Appl. No.: 17/063,567

(22) Filed: Oct. 5, 2020

(51) Int. Cl. H01M 4/36; H01M 4/62; H01M 10/052; H01M 4/139; H01M 4/38

(52) U.S. Cl. CPC H01M 4/366; H01M 4/622; H01M 10/052; H01M 2004/021; H01M 4/139; H01M 4/386; H01M 4/625

(57) ABSTRACT

Provided is porous anode or cathode electrode for a lithium battery, the porous electrode comprising multiple particles of an electrode active material (with or without a high-elasticity polymer coating deposited thereon), an optional conductive additive, and a high-elasticity polymer binder that bonds the particles and conductive additive together to form the electrode wherein the multiple particles have pores occupying a pore volume faction Vp and the electrode has pores, external to the multiple particles, occupying a volume faction Ve, wherein Ve and Vp are all based on the total electrode volume, not counting the volume of an electrode current collector, and the total pore volume fraction Vt=Vp+Ve is from 10% to 80% in such a manner that the volume expansion of the electrode during battery charge/discharge operations does not exceed 30% (preferably <20%, more preferably <10% and most preferably 0%).

### FIELD

The present disclosure relates generally to the field of rechargeable lithium battery and, more particularly, to the lithium battery anode, cathode and cell, and a method of manufacturing same.

### BACKGROUND

A unit cell or building block of a lithium-ion battery is typically composed of an anode current collector, an anode or negative electrode layer (containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte.

The binder in the anode layer is used to bond the anode active material (e.g. graphite or Si particles) and a conductive filler (e.g. carbon black particles or carbon nanotube) together to form an anode layer of structural integrity, and to bond the anode layer to a separate anode current collector, which acts to collect electrons from the anode active material when the battery is discharged. In other words, in the negative electrode (anode) side of the battery, there are typically four different materials involved: an anode active material, a conductive additive, a resin binder (e.g. polyvinylidine fluoride, PVDF, or styrene-butadiene rubber, SBR), and an anode current collector (typically a sheet of Cu foil). Typically the former three materials form a separate, discrete anode active material layer (or, simply, anode layer) and the latter one forms another discrete layer.

A binder resin (e.g. PVDF or PTFE) is also used in the cathode to bond cathode active materials and conductive additive particles together to form a cathode active layer of structural integrity. The same resin binder also acts to bond this cathode active layer to a cathode current collector.

The most commonly used anode active materials for lithium-ion batteries are natural graphite and synthetic graphite (or artificial graphite) that can be intercalated with lithium and the resulting graphite intercalation compound (GIC) may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the charge transfer purpose. As the SEI is formed, the lithium ions become part of the inert SEI layer and become irreversible, i.e. these positive ions can no longer be shuttled back and forth between the anode and the cathode during charges/discharges. Therefore, it is desirable to use a minimum amount of lithium for the formation of an effective SEI layer. In addition to SEI formation, the irreversible capacity loss Qᵢᵣ can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity anode active materials, severe pulverization (fragmentation of the alloy particles) and detachment of active material particles from the resin binder occur during the charge and discharge cycles. These are due to severe expansion and contraction of the anode active material particles induced by the insertion and extraction of the lithium ions in and out of these particles. The expansion and contraction, the resulting pulverization, of active material particles and detachment from the resin binder lead to loss of contacts between active material particles and conductive additives and loss of contacts between the anode active material and its current collector. These adverse effects result in a significantly shortened charge-discharge cycle life.

To overcome some of the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film must have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g. up to a volume expansion of 380%) during the battery charge step, the protective coating is easily broken due to the mechanical weakness and/o brittleness of the protective coating materials. There has been no high-strength and high-toughness material available that is itself also lithium ion conductive.
   It may be further noted that the coating or matrix materials used to protect active particles (such as Si and Sn) are carbon, sol gel graphite, metal oxide, monomer, ceramic, and lithium oxide. These protective materials are all very brittle, weak (of low strength), and/or non-conducting (e.g., ceramic or oxide coating). It is commonly believed that the protective material should meet the following requirements: (a) The coating or matrix material should be of high strength and high stiffness that it can help to refrain the electrode active material particles, when lithiated, from expanding to an excessive extent. (b) The protective material should also have high fracture toughness or high resistance to crack formation to avoid disintegration during repeated cycling. (c) The protective material must be inert (inactive) with respect to the electrolyte, but be a good lithium ion conductor. (d) The protective material must not provide any significant amount of defect sites that irreversibly trap lithium ions. (e) The protective material must be lithium ion-conducting as well as electron-conducting. The prior art protective materials all fall short of these requirements. Hence, it was not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.
      Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g. those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, polymeric carbon, amorphous carbon, or pre-graphitic carbon may have too many lithium-trapping sites that irreversibly capture lithium during the first few cycles, resulting in excessive irreversibility.

In summary, the prior art has not demonstrated a composite material and other approaches that can effectively reduce or eliminate the expansion/shrinkage-induced problems of the anode active material in a lithium-ion battery. Thus, there is an urgent and continuing need for a new protective or binder material that enables a lithium-ion battery to exhibit a long cycle life. There is also a need for a method of readily or easily producing such a material in large quantities.

Thus, it is an object of the present disclosure to develop an electrode that meets these needs and address the issues associated the rapid capacity decay of a lithium battery containing a high-capacity anode or cathode active material. Some cathode active materials (e.g. sulfur) also undergo large volume expansion and shrinkage and these issues must also be addressed.

### SUMMARY

The present disclosure provides a porous electrode (anode or cathode) for a lithium battery, the porous electrode comprising multiple particles of an electrode active material (anode active material or cathode active material), an optional conductive additive, and a polymer binder that bonds the multiple particles and the conductive additive together to form this electrode wherein the multiple particles have pores occupying a pore volume faction Vp and the electrode has additional pores, external to the multiple particles (not part of the pores in these particles), occupying a volume faction Ve, wherein Ve and Vp are all based on the total electrode volume, not counting the volume of an electrode current collector, and the total pore volume fraction Vt=Vp+Ve is from 10% to 80% in such a manner that a volume expansion of the electrode in a battery cell during battery charge/discharge operations does not exceed 30% (preferably less than 20%, further preferably less than 10% and most preferably approximately 0%) to ensure electrode stability and structural integrity.

In certain embodiments, the multiple particles comprise porous primary particles, porous secondary particles, or a combination of porous primary and secondary particles. The primary particles can be porous having internal pores or surface pores, as illustrated in FIG. 2(E). When one or a plurality of solid or porous primary particles are encapsulated by an elastic polymer coating to form secondary particles (particulates), these secondary particles can contain pores inside the constituent primary particles or between the primary particles and the encapsulating shell.

In some embodiments, the total pore volume fraction Vt is from 20% to 70% or the volume expansion of the electrode in a battery cell during battery charge/discharge operations does not exceed 10%.

In some embodiments, the multiple particles are coated with or encapsulated by a high-elasticity coating polymer having a recoverable tensile strain from 5% to 700%, when measured without the conductive additive dispersed in the coating polymer, and the lithium ion conductivity no less than 10⁻⁸ S/cm.

In the porous electrode, the polymer binder preferably comprises a high-elasticity polymer having a recoverable tensile strain from 5% to 700%, when measured without an additive dispersed in said polymer. This highly elastic polymer binder can help hold the electrode active material particles and the conductive additive together even when the electrode active material particles undergo large volume expansions during battery charge/discharge operations.

Preferably, inside the porous electrode, the multiple particles are coated with or encapsulated by a high-elasticity coating polymer having a recoverable tensile strain from 5% to 700% and the lithium ion conductivity no less than 10⁻⁸ S/cm and the electrode further comprises a high-elasticity polymer binder having a recoverable tensile strain from 5% to 700% when measured without an additive dispersed in the binder polymer.

In the porous electrode, electrode particles are coated with or encapsulated by a high-elasticity coating polymer having a recoverable tensile strain from 5% to 700% or wherein the polymer binder comprises a high-elasticity binder polymer having a recoverable tensile strain from 5% to 700%, wherein the coating polymer and/or the binder polymer further comprises a 0.01%-50% by weight of a conductive reinforcement material dispersed in the coating polymer or the binder polymer or bonded by the binder polymer.

In certain embodiments, the disclosure provides a highly elastic polymer composite binder composition for use in an anode or cathode of a lithium battery, the composition comprising a polymerizing or cross-linking liquid precursor and a 0%-50% by weight of a conductive reinforcement material dispersed in the liquid precursor. The liquid precursor is capable of chemically bonding to an anode active material or cathode active material in the lithium battery upon completion of polymerization or cross-linking reactions to form a high-elasticity polymer. The polymerization and/or cross-linking reactions may be initiated and/or accelerated by using heat, UV radiation, or other forms of energy. The resulting high-elasticity polymer has a recoverable tensile strain from 5% to 700% when measured without the conductive reinforcement dispersed in the polymer. Once polymerized and cured or cross-linked, the resulting polymer is chemically bonded to the electrode active material (e.g. anode or cathode particles) and the conductive additive particles (e.g. carbon black particles, carbon nano-tubes, etc.), helping to hold these particles together to maintain structural integrity. The binder is also bonded to a surface of a current collector (e.g. Cu foil or Al foil).

In the disclosed binder composition, the conductive reinforcement may be preferably selected from the group consisting of carbon nanotubes, graphene sheets, carbon nano-fibers, graphite nano-fibers, carbon fibers, graphite fibers, expanded graphite flakes, carbon black, acetylene black, carbon particles, graphite particles, metal nanowires or whiskers, and combinations thereof.

In the binder composition, the resulting high-elasticity polymer (after polymerization and crosslinking) may contain a cross-linked network polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in the cross-linked network of polymer chains. These linkages or their precursor molecules may be present in the liquid precursor.

In some embodiments, the high-elasticity polymer in the binder composition, after polymerization and crosslinking, contains a cross-linked network of polymer chains selected from nitrile-containing polyvinyl alcohol chains, cyanoresin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

In some embodiments, the high-elasticity polymer in the binder composition, after polymerization and crosslinking, contains a cross-linked network of polymer chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulfide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof, and wherein the high-elasticity polymer has a recoverable tensile strain from 5% to 700%, when measured without a conductive additive or reinforcement dispersed in the polymer.

The binder composition may further comprise a lithium-ion conducting material dispersed in said liquid precursor. The lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4.

The lithium ion-conducting additive may be preferably selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

In some embodiments, the lithium ion-conducting additive is selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

The binder composition, after polymerization and crosslinking, may result in a high-elasticity polymer having lithium ion conductivity from 1×10⁻⁸ S/cm to 2×10⁻² S/cm.

The binder composition may further comprise a foaming agent or blowing agent dispersed in the liquid precursor. This foaming or blowing agent will help the formation of pores in the resulting electrodes (anode or cathode).

In certain preferred embodiments, the high-elasticity polymer has a lithium ion conductivity no less than 10⁻⁸ S/cm at room temperature. Preferably, the high-elasticity polymer contains a cross-linked network of polymer chains. Examples of the cross-linked networks of polymer chains were described above.

This high-elasticity polymer has a recoverable tensile strain (elastic deformation) no less than 5% when measured without an additive or reinforcement in the polymer and preferably a lithium ion conductivity no less than 10⁻⁶ S/cm at room temperature.

The high-elasticity polymer has a recoverable tensile strain no less than 5% (typically 10-700%, more typically 30-500%, further more typically and desirably >50%, and most desirably >100%) when measured without an additive or reinforcement in the polymer under uniaxial tension. The polymer preferably also has a lithium ion conductivity no less than 10⁻⁵ S/cm at room temperature (preferably and more typically no less than 10⁻⁴ S/cm and more preferably and typically no less than 10⁻³ S/cm). The anode active material preferably has a specific capacity of lithium storage greater than 372 mAh/g, which is the theoretical capacity of graphite.

High-elasticity polymer refers to a polymer, typically a lightly cross-linked polymer network, which exhibits an elastic deformation that is at least 5% when measured (without an additive or reinforcement in the polymer) under uniaxial tension. In the field of materials science and engineering, the “elastic deformation” is defined as a deformation of a material (when being mechanically stressed) that is essentially fully recoverable upon release of the load and the recovery process is essentially instantaneous. The elastic deformation is preferably greater than 30%, more preferably greater than 50%, further more preferably greater than 100%, still more preferably greater than 150%, and most preferably greater than 200%.

This anode or cathode may further comprise a conductive reinforcement dispersed in the high-elasticity polymer and the conductive reinforcement is selected from the group consisting of carbon nanotubes, graphene sheets, carbon nano-fibers, graphite nano-fibers, carbon fibers, graphite fibers, expanded graphite flakes, carbon black, acetylene black, carbon particles, graphite particles, metal nanowires or whiskers, and combinations thereof.

There is no particular limitation on the type of anode active material that can be chosen. In this anode active material layer, the anode active material may be selected from the group consisting of: (a) silicon (Si), germanium (Ge), tin (Sn), lead (Pb), phosphorus (P), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo₂O₄; (f) prelithiated versions thereof; (g) particles of Li, Li alloy, or surface-stabilized Li having at least 60% by weight of lithium element therein; (h) particles or fibers of carbon and graphite; and (i) combinations thereof.

In some preferred embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

It may be noted that pre-lithiation of an anode active material means that this material has been pre-intercalated by or doped with lithium ions up to a weight fraction from 0.1% to 54.7% of Li in the lithiated product.

There is also no particular limitation on the type of cathode active materials that can be used for practicing instant disclosure.

The cathode active material particles may contain a cathode active material selected from an inorganic material, an organic material, a polymeric material, or a combination thereof. The inorganic material may be selected from a metal oxide, metal phosphate, metal silicide, metal selenide, transition metal sulfide, sulfur, lithium polysulfide, selenium, lithium selenide, or a combination thereof.

The inorganic material may be selected from a lithium cobalt oxide, lithium nickel oxide, lithium manganese oxide, lithium vanadium oxide, lithium-mixed metal oxide (such as the well-known NMC, NCA, etc., where N=I, M=Mn, C=Co, and A=Al in these two examples), lithium iron phosphate, lithium manganese phosphate, lithium vanadium phosphate, lithium mixed metal phosphate, lithium metal silicide, or a combination thereof.

In certain preferred embodiments, the inorganic material-based cathode active material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In certain preferred embodiments, the inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

In certain preferred embodiments, the inorganic material is selected from a transition metal dichalcogenide, a transition metal trichalcogenide, or a combination thereof. The inorganic material is selected from TiS₂, TaS₂, MoS₂, NbSe₃, MnO₂, CoO₂, an iron oxide, a vanadium oxide, or a combination thereof.

The cathode active material layer may contain a metal oxide containing vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In some embodiments, the inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. The cathode active material layer may contain an organic material or polymeric material selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAM), calixquinone, Li₄C₆O₆, Li₂C₆O₆, Li₆C₆O₆, or a combination thereof.

The thioether polymer is selected from Poly[methanetetryl-tetra(thiomethylene)] (PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

In other embodiments, the cathode active material layer contains an organic material selected from a phthalocyanine compound, such as copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The anode or cathode active material is preferably in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. Further preferably, the anode active material has a dimension less than 50 nm, even more preferably less than 20 nm, and most preferably less than 10 nm. However, in some embodiments, the anode active material contains a sub-micron or micron particle having a dimension from 100 nm to 30 μm.

In some embodiments, multiple particles are bonded by the high-elasticity polymer-based binder resin. A carbon layer, graphene layer, or high-elasticity polymer coating layer (referred to as the second high-elasticity polymer or “coating polymer”) may be deposited to embrace the anode or cathode active material particles prior to being bonded by the resin binder, wherein the high-elasticity polymer coating has a recoverable tensile strain from 5% to 700% when measured without a conductive additive or reinforcement dispersed in the polymer coating and wherein the polymer coating has a lithium ion conductivity no less than 10⁻⁷ S/cm at room temperature.

This high-elasticity polymer coating (or the second high-elasticity polymer) may be the same as or different than the high-elasticity polymer binder (the first high-elasticity polymer or “binder polymer”) in chemical composition and structure.

The anode or cathode active material layer may further contain a graphite, graphene, or carbon material mixed with the active material particles in the anode active material layer. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The anode or cathode active material particles may be coated with or embraced by a conductive protective coating, selected from a carbon material, graphene, electronically conductive polymer, conductive metal oxide, or conductive metal coating. Preferably, the anode active material, in the form of a nano particle, nano wire, nano fiber, nano tube, nano sheet, nano belt, nano ribbon, nano disc, nano platelet, or nano horn is pre-intercalated or pre-doped with lithium ions to form a prelithiated anode active material having an amount of lithium from 0.1% to 54.7% by weight of said prelithiated anode active material.

Preferably, the high-elasticity coating polymer has a lithium ion conductivity no less than 10⁻⁵ S/cm, more preferably no less than 10⁻⁴ S/cm, and most preferably no less than 10⁻³ S/cm. Some of the selected polymers exhibit a lithium-ion conductivity greater than 10⁻² S/cm.

In some embodiments, the high-elasticity coating polymer is a polymer matrix composite containing from 0.1% to 50% by weight (preferably from 1% to 35% by weight) of a lithium ion-conducting additive dispersed in a high-elasticity polymer matrix material. Examples of lithium ion-conducting additives were discussed in previous paragraphs.

In some embodiments, the high-elasticity coating polymer comprises an elastomer selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The high-elasticity polymer may form a mixture or blend with an electron-conducting polymer selected from polyaniline, polypyrrole, polythiophene, polyfuran, a bi-cyclic polymer, derivatives thereof (e.g. sulfonated versions), or a combination thereof.

Other high-elasticity polymers that can be used herein as a coating polymer were described above (e.g. those containing a cross-linked network of polymer chains listed earlier) and will not be repeated here.

In some preferred embodiments, the anode active material layer contains voids in a sufficient amount to accommodate a volume expansion of the anode active material particles during a charge procedure of a lithium battery comprising the anode layer so that the anode layer undergoes a volume change of less than 20%, preferably less than 10%, and most preferably substantially 0%. The voids or pores may be produced by introducing a blowing agent or foaming agent into the anode electrode layer when the layer is formed.

The present disclosure also provides a lithium battery containing an optional anode current collector, the presently invented anode active material layer as described above, a cathode active material layer, an optional cathode current collector, an electrolyte in ionic contact with the anode active material layer and the cathode active material layer and an optional porous separator or lithium ion-permeable membrane. The disclosure also provides a lithium battery that contains a presently disclosed cathode active layer.

The lithium battery may be a lithium-ion battery, lithium metal battery (containing lithium metal or lithium alloy as the main anode active material and containing no intercalation-based anode active material), lithium-sulfur battery, lithium-selenium battery, or lithium-air battery.

The present disclosure also provides a method of manufacturing a lithium battery anode or cathode, the method comprising:
(a) encapsulating multiple particles (primary particles) of an anode or cathode active material with a high-elasticity coating polymer to form multiple secondary particles having pores therein wherein the coating polymer has a recoverable tensile strain from 5% to 700%, when measured without an additive or reinforcement dispersed in the coating polymer, and a lithium ion conductivity no less than 10⁻⁸ S/cm; and
(b) a procedure of forming the electrode by (i) bonding multiple secondary particles and an optional conductive additive together through the use of a binder resin containing a high-elasticity binder polymer, wherein the high-elasticity binder polymer comprises a cross-linked network of polymer chains and the high-elasticity polymer has a recoverable tensile strain from 5% to 700% when measured without an additive or reinforcement dispersed in said binder polymer; and (ii) generating additional pores, external to the secondary particles (outside of the secondary particles), in the electrode; wherein the pores in the secondary particles occupy a pore volume fraction Vp and the additional pores occupy a pore volume fraction Ve based on the total electrode volume, not counting the volume of an electrode current collector, and the total pore volume fraction Vt=Vp+Ve is from 10% to 80% in such a manner that a volume expansion of the electrode in a battery cell during battery charge/discharge operations does not exceed 30% (preferably less than 20%, further preferably less than 10% and most preferably being approximately 0%).

In the method, the procedure of producing additional pores in the electrode may comprise a step of using a foaming agent that produce closed-cell or open-cell pores.

Preferably, the high-elasticity coating polymer has a lithium ion conductivity from 1×10⁻⁸ S/cm to 2×10⁻² S/cm. In some embodiments, the high-elasticity coating polymer has a recoverable tensile strain from 10% to 300% (more preferably >50%, and most preferably >100%).

In certain preferred embodiments, the high-elasticity coating polymer or binder polymer contains a cross-linked network of polymer chains. Examples of these chains were discussed earlier. Again, the binder composition may contain a lithium ion-conducting material dispersed in the high-elasticity polymer.

Preferably, the anode or cathode active material particles are coated with a layer of carbon or graphene (plus a high-elasticity ion-conducting polymer coating) prior to being bonded by the high-elasticity polymer composite binder. Preferably, anode active material particles and particles of a carbon or graphite material are bonded together by the high-elasticity polymer. Preferably, the anode active material particles, possibly along with a carbon or graphite material and/or with some internal graphene sheets, are embraced by graphene sheets to form anode active material particulates, which are then bonded by the high-elasticity polymer. The graphene sheets may be selected from pristine graphene (e.g. that prepared by CVD or liquid phase exfoliation using direct ultrasonication), graphene oxide, reduced graphene oxide (RGO), graphene fluoride, doped graphene, functionalized graphene, etc.

### BRIEF DESCRIPTION OF THE DRAWINGS

FIG. 1(A) Schematic of a prior art lithium-ion battery cell, wherein the anode layer is a thin coating of an anode active material itself.

FIG. 1(B) Schematic of another prior art lithium-ion battery; the anode layer being composed of particles of an anode active material, a conductive additive (not shown) and a resin binder (not shown).

FIG. 2(A) Schematic illustrating the notion that expansion of Si particles, upon lithium intercalation during charging of a prior art lithium-ion battery, can lead to pulverization of Si particles, detachment of resin binder from the particles, and interruption of the conductive paths formed by the conductive additive, and loss of contact with the current collector;

FIG. 2(B) Schematic illustrating the notion that expansion of a Si particle (coated with a non-elastic coating, such as carbon), upon lithium intercalation during charging of a prior art lithium-ion battery, can lead to a broken coating;

FIG. 2(C) Schematic illustrating the notion that expansion of a Si particle (coated with an elastic coating), upon lithium intercalation during charging of a lithium-ion battery, can remain protected by the elastic polymer coating; the elastic polymer expands and shrinks congruently with the Si particle;

FIG. 2(D) Schematic illustrating a porous electrode (an anode or cathode, according to some embodiments of the disclosure) having high-elasticity polymer-coated Si particles, an optional conductive filler or additive, a highly elastic polymer binder that bonds the Si particles and the conductive additive together; the Si particles per se (the primary particles) may be porous and/or the secondary particles (comprising one or a plurality of primary particles encapsulated by an elastic polymer coating) may contain pores inside the encapsulating shell but outside the primary particles.

FIG. 2(E) Schematic illustrating some embodiments of the present disclosure, wherein a porous secondary particle (or porous particulate) may be produced from one or multiple primary particles.

FIG. 3(A) Representative tensile stress-strain curves of four BPO-initiated cross-linked ETPTA polymers.

FIG. 3(B) The specific capacity values of two lithium battery cells having an anode active material featuring (1) ETPTA polymer composite binder-bonded Co₃O₄ particles and SBR rubber-bonded Co₃O₄ particles.

FIG. 4(A) Representative tensile stress-strain curves of four PF5-initiated cross-linked PVA-CN polymers.

FIG. 4(B) The specific capacity values of two lithium battery cells having an anode active material featuring (1) high-elasticity PVA-CN polymer composite binder-bonded SnO₂ particles and (2) PVDF-bonded SnO₂ particles, respectively.

FIG. 5(A) Representative tensile stress-strain curves of three cross-linked PETEA polymers FIG. 5(B) The discharge capacity curves of four coin cells having four different types of anode active layers: (1) high-elasticity PETEA polymer composite binder-bonded, carbon-coated Sn particles, (2) high-elasticity PETEA polymer composite binder-bonded Sn particles; (3) SBR rubber-bonded, carbon-coated Sn particles; and (d) PVDF-bonded Sn particles.

FIG. 6 Specific capacities of 2 lithium-ion cells each having Si nanowires (SiNW) as an anode active material: high-elasticity polymer composite binder-bonded SiNW and SBR rubber binder-bonded SiNW.

FIG. 7 shows the Coulombic efficiency and specific capacity data of two cells each comprising a porous anode comprising PANI-coated Si particles which are bonded by PANI network/graphene based binder resin. The upper curve is from the electrode having a pore volume fraction of approximately 45% and the lower curve 31%, calculated from physical density data.

### DESCRIPTION OF THE PREFERRED EMBODIMENTS

This disclosure is directed at the anode or cathode active material layer (negative or positive electrode layer, not including the current collector) containing particles of a high-capacity anode or cathode material for a lithium secondary battery, which is preferably a secondary battery based on a non-aqueous electrolyte, a polymer gel electrolyte, an ionic liquid electrolyte, a quasi-solid electrolyte, or a solid-state electrolyte. The shape of a lithium secondary battery can be cylindrical, square, button-like, etc. The present disclosure is not limited to any battery shape or configuration or any type of electrolyte. For convenience, we will primarily use Si, Sn, and SnO₂ as illustrative examples of a high-capacity anode active material. This should not be construed as limiting the scope of the disclosure.

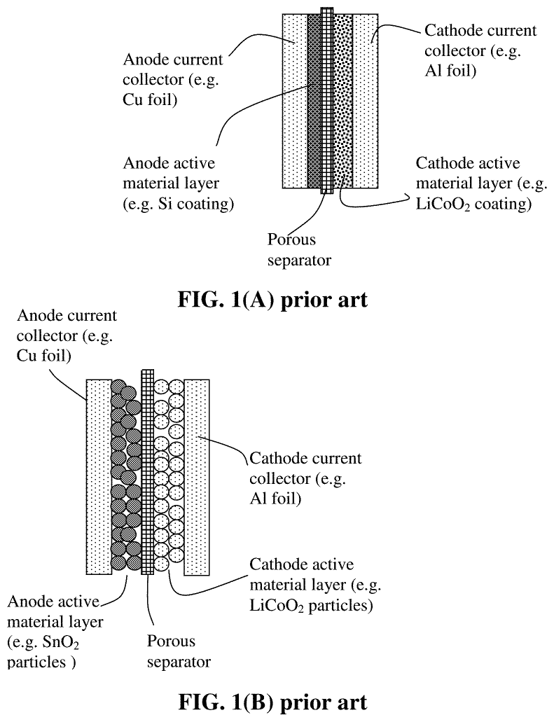

As illustrated in FIG. 1(B), a lithium-ion battery cell is typically composed of an anode current collector (e.g. Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, or Si), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

In a less commonly used cell configuration, as illustrated in FIG. 1(A), the anode active material is deposited in a thin film form directly onto an anode current collector, such as a layer of Si coating deposited on a sheet of copper foil. This is not commonly used in the battery industry and, hence, will not be discussed further.

In order to obtain a higher energy density cell, the anode in FIG. 1(B) can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as discussed in the Background section, there are several problems associated with the implementation of these high-capacity anode active materials.

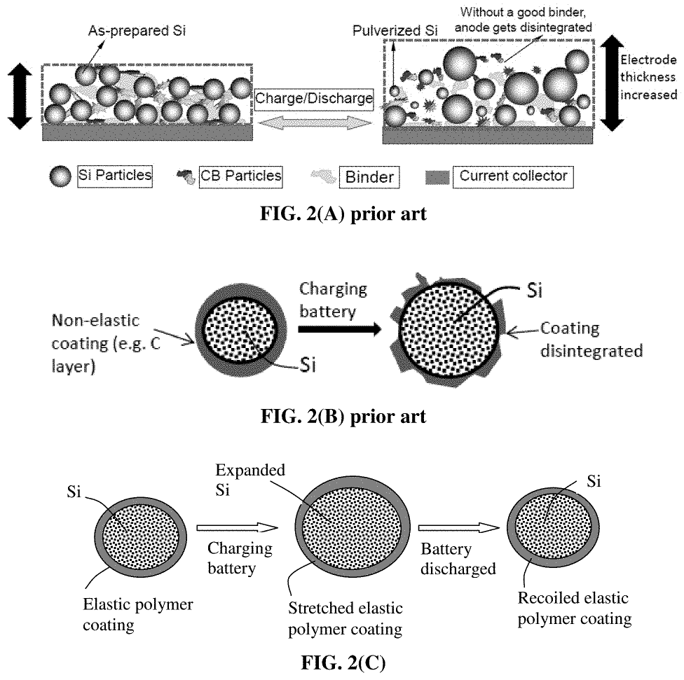

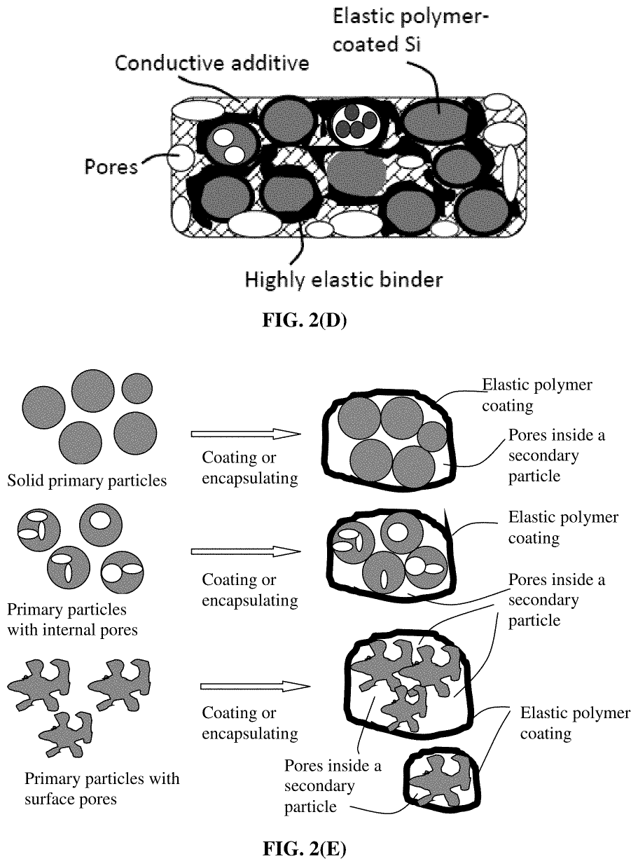

As schematically illustrated in FIG. 2(A), one major problem is the notion that, in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction of the active material particles leads to the pulverization of active material particles and detachment of the binder resin from the particles, resulting in loss of contacts between active material particles and conductive additives and loss of contacts between the anode active material and its current collector. These adverse effects result in a significantly shortened charge-discharge cycle life.

We have solved these challenging issues that have troubled battery designers and electrochemists alike for more than 30 years by combining the following three approaches: (a) high-elasticity polymer coated particles, (b) a new class of binder resin to hold these coated particles of the active material and an optional conductive additive together to form an electrode, and (c) implementing a controlled amount of pores in the electrode.

The present disclosure provides a porous electrode (anode or cathode) for a lithium battery, the porous electrode comprising multiple particles of an electrode active material (anode active material or cathode active material), an optional conductive additive, and a polymer binder that bonds the multiple particles and the conductive additive together to form this electrode wherein the multiple particles have pores occupying a pore volume faction Vp and the electrode has additional pores, external to the multiple particles (not part of the pores in these particles), occupying a volume faction Ve, wherein Ve and Vp are all based on the total electrode volume, not counting the volume of an electrode current collector, and the total pore volume fraction Vt=Vp+Ve is from 10% to 80% in such a manner that a volume expansion of the electrode in a battery cell during battery charge/discharge operations does not exceed 30% (preferably less than 20%, further preferably less than 10% and most preferably approximately 0%) to ensure electrode stability and structural integrity.

In certain embodiments, the multiple particles comprise porous primary particles, porous secondary particles, or a combination of porous primary and secondary particles. The primary particles can be porous having internal pores or surface pores, as illustrated in FIG. 2(E). When one or a plurality of solid or porous primary particles are encapsulated by an elastic polymer coating to form secondary particles (particulates), these secondary particles can contain pores inside the constituent primary particles or between the primary particles and the encapsulating shell.

In some embodiments, the total pore volume fraction Vt is from 20% to 70% or the volume expansion of the electrode in a battery cell during battery charge/discharge operations does not exceed 10%. The high-elasticity polymer has a recoverable tensile strain no less than 5% when measured without an additive or reinforcement in the polymer under uniaxial tension and preferably a lithium ion conductivity no less than 10⁻⁸ S/cm at room temperature (preferably y no less than 10⁻⁵ S/cm and more preferably and typically no less than 10⁻⁴ S/cm). The anode active material is preferably a high-capacity anode material that has a specific capacity of lithium storage greater than 372 mAh/g, which is the theoretical capacity of graphite.

High-elasticity polymer refers to a polymer, typically a lightly cross-linked polymer, which exhibits an elastic deformation that is at least 5% when measured (without an additive or reinforcement in the polymer) under uniaxial tension. In the field of materials science and engineering, the “elastic deformation” is defined as a deformation of a material (when being mechanically stressed) that is essentially fully recoverable and the recovery is essentially instantaneous upon release of the load. The elastic deformation is preferably greater than 30%, more preferably greater than 50%, further more preferably greater than 100%, still more preferably greater than 150%, and most preferably greater than 200%. The preferred types of high-capacity polymers will be discussed later.

As schematically illustrated in FIG. 2(B), volume expansion of a Si particle (coated with a non-elastic coating, such as carbon), as induced by lithium intercalation during charging of a lithium-ion battery, can lead to disintegration of the coating layer. If this coating layer contains a solid-electrolyte interface (SEI) material, the SEI layer will be destructed and new SEI will be formed during the next charge/discharge cycles, which consumes electrolyte and lithium ions, leading to a rapid decay of the battery capacity.

In contrast, as illustrated in FIG. 2(C), if a Si particle is coated with an elastic polymer coating, the elastic polymer expands and shrinks congruently with the Si particle upon lithium intercalation and de-intercalation during charging and discharging of a lithium-ion battery. The Si particle (as an example of a high-capacity anode material) can remain protected by the elastic polymer coating.

According to some embodiments of the disclosure, FIG. 2(D) schematically illustrates a porous electrode (an anode or cathode) having high-elasticity polymer-coated Si particles, an optional conductive filler or additive, a highly elastic polymer binder that bonds the Si particles and the conductive additive together. The Si particles as the primary particles may be porous. The secondary particles (comprising one or a plurality of primary particles encapsulated by an elastic polymer coating) may contain pores inside the encapsulating shell but outside the primary particles. As illustrated in FIG. 2(E), a porous secondary particle (or porous particulate) may be produced from one or multiple primary particles which are porous (having internal pores or surface pores) or non-porous. The pores of the primary particles can allow the particle to expand into the free space without a significant overall volume increase of the particulate and without inducing any significant volume expansion of the entire anode electrode.

The primary anode active material particles are preferably porous, having surface pores or internal pores, as schematically illustrated in FIG. 2(E). The production methods of porous particles are well-known in the art. For instance, the production of porous Si particles may be accomplished by etching particles of a Si—Al alloy using HCl solution (to remove the Al element leaving behind pores) or by etching particles of a Si—SiO₂ mixture using HF solution (by removing SiO₂ to create pores).

Porous SnO₂ nano particles may be synthesized by a modified procedure described by Gurunathan et al [P. Gurunathan, P. M. Ette and K. Ramesha, ACS Appl. Mater. Inter., 6 (2014) 16556-16564]. In a typical synthesis procedure, 8.00 g of SnCl₂.6H₂O, 5.20 g of resorcinol and 16.0 mL of 37% formaldehyde solution were mixed in 160 mL of H₂O for about 30 minutes. Subsequently, the solution is sealed in a 250 mL round-bottom flask and kept in water bath at 80° C. for 4 hours. The resulting red gel is dried at 80° C. in an oven and calcined at 700° C. for 4 hours in N₂ and air atmosphere in sequence. Finally, the obtained white SnO₂ may be mechanically ground into finer powder for 30-60 minutes in mortar.

All types of porous anode active material particles may be produced by depositing the anode active material onto surfaces or into pores of a sacrificial material structure, followed by removing the sacrificial material. Such a deposition can be conducted using CVD, plasma-enhanced CVD, physical vapor deposition, sputtering, solution deposition, melt impregnation, chemical reaction deposition, etc.

The anode active material may be selected from the group consisting of: (a) silicon (Si), germanium (Ge), tin (Sn), lead (Pb), phosphorus (P), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide (e.g. various vanadium oxides, lithium titanium niobium oxides, etc.), ZnCo₂O₄; (f) prelithiated versions thereof; (g) particles of Li, Li alloy, or surface-stabilized Li; and (h) combinations thereof. Particles of Li or Li alloy (Li alloy containing from 0.1% to 10% by weight of Zn, Ag, Au, Mg, Ni, Ti, Fe, Co, or V element), particularly surface-stabilized Li particles (e.g. wax-coated Li particles), were found to be good anode active material per se or an extra lithium source to compensate for the loss of Li ions that are otherwise supplied only from the cathode active material. The presence of these Li or Li-alloy particles encapsulated inside an elastomeric shell was found to significantly improve the cycling performance of a lithium cell.

Pre-lithiation of an anode active material can be conducted by several methods (chemical intercalation, ion implementation, and electrochemical intercalation). Among these, the electrochemical intercalation is the most effective. Lithium ions can be intercalated into non-Li elements (e.g. Si, Ge, and Sn) and compounds (e.g. SnO₂ and Co₃O₄) up to a weight percentage of 54.68% (see Table 1 below). For Zn, Mg, Ag, and Au encapsulated inside an elastomer shell, the amount of Li can reach 99% by weight.

TABLE 1
Lithium storage capacity of selected non-Li elements.

| Intercalated | Atomic weight | Atomic weight of | Max. wt. % |
|---|---|---|---|
| compound | of Li, g/mole | active material, g/mole | of Li |
| Li₄Si | 6.941 | 28.086 | 49.71 |
| Li_{4.4}Si | 6.941 | 28.086 | 54.68 |
| Li_{4.4}Ge | 6.941 | 72.61 | 30.43 |
| Li4.4Sn | 6.941 | 118.71 | 20.85 |
| Li₃Cd | 6.941 | 112.411 | 14.86 |
| Li₃Sb | 6.941 | 121.76 | 13.93 |
| Li_{4.4}Pb | 6.941 | 207.2 | 13.00 |
| LiZn | 6.941 | 65.39 | 7.45 |
| Li₃Bi | 6.941 | 208.98 | 8.80 |

The particles of the anode active material may be in the form of a nano particle, nano wire, nano fiber, nano tube, nano sheet, nano platelet, nano disc, nano belt, nano ribbon, or nano horn. They can be non-lithiated (when incorporated into the anode active material layer) or prelithiated to a desired extent (up to the maximum capacity as allowed for a specific element or compound. In some embodiments, the anode active material contains a sub-micron or micron particle having a dimension from 100 nm to 30 μm.

Preferably, the high-elasticity coating polymer has a lithium ion conductivity no less than 10⁻⁵ S/cm, more preferably no less than 10⁻⁴ S/cm, further preferably no less than 10⁻³ S/cm, and most preferably no less than 10⁻² S/cm. In some embodiments, the high-elasticity polymer is a polymer matrix composite containing from 0.01% to 50% (preferably 0.1% to 35%) by weight of a lithium ion-conducting additive dispersed in a high-elasticity polymer matrix material. The high-elasticity polymer must have a high elasticity (elastic deformation strain value >5%). An elastic deformation is a deformation that is fully recoverable and the recovery process is essentially instantaneous (no significant time delay). The high-elasticity polymer can exhibit an elastic deformation from 5% up to 1,000% (10 times of its original length), more typically from 10% to 800%, and further more typically from 50% to 500%, and most typically and desirably from 70% to 300%. It may be noted that although a metal typically has a high ductility (i.e. can be extended to a large extent without breakage), the majority of the deformation is plastic deformation (non-recoverable) and only a small amount of elastic deformation (typically <1% and more typically <0.2%).

In some preferred embodiments, the high-elasticity coating polymer or binder contains a lightly cross-linked network polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof, in the cross-linked network of polymer chains. These network or cross-linked polymers exhibit a unique combination of a high elasticity (high elastic deformation strain) and high lithium-ion conductivity.

In certain preferred embodiments, the high-elasticity polymer (coating polymer or binder polymer) contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, or a combination thereof.

The high-elasticity coating polymer or binder polymer may contain a conducting polymer network of cross-linked chains comprising chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulfide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

Typically, a high-elasticity polymer is originally in a monomer or oligomer states that can be cured to form a cross-linked polymer that is highly elastic. Prior to curing, these polymers or oligomers are soluble in an organic solvent to form a polymer solution. In some cases, the monomers are in a liquid state and may not require a solvent as a liquid medium. Particles of an anode active material (e.g. SiO and SnO₂ nano particles and Si nano-wires), along with a conductive filler and/or reinforcement material (e.g. CNTs, carbon nano-fibers, graphene sheets, expanded graphite flakes, etc.) can be dispersed in this polymer solution to form a suspension (dispersion or slurry). This suspension may be spray-dried to produce elastic polymer-coated particles. This suspension can also be coated onto a surface of a current collector (e.g. a primary surface or both primary surfaces of a Cu foil), followed by a solvent removal treatment.

For instance, ethoxylated trimethylopropane triacrylate monomer (ETPTA, Mw=428, chemical formula given below), along with an initiator, can be dissolved in an organic solvent, such as ethylene carbonate (EC) or diethyl carbonate (DEC). Then, elastic polymer-coated anode active material particles (Si, Sn, SnO₂, and Co₃O₄ particles, etc.) and conductive reinforcement material (CNTs, graphene sheets, etc.) can be dispersed in the ETPTA monomer/solvent/initiator solution to form a slurry, which can be spray-coated onto a Cu foil to form ETPTA monomer/initiator-coated Cu foil. This coating layer can then be thermally cured to obtain an anode electrode comprising elastic polymer-coated anode particles bonded by a high-elasticity polymer and a conductive reinforcement material. The polymerization and cross-linking reactions of this monomer can be initiated by a radical initiator derived from benzoyl peroxide (BPO) or AIBN through thermal decomposition of the initiator molecule. The ETPTA monomer has the following chemical formula:

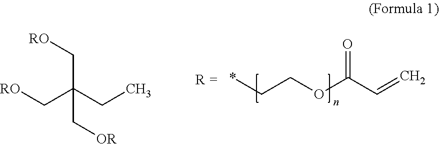

As another example, the high-elasticity polymer for coating or for binding may be based on cationic polymerization and cross-linking of the cyanoethyl polyvinyl alcohol (PVA-CN, Formula 2) in succinonitrile (SN).

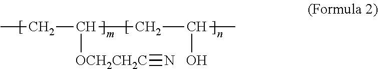

The procedure may begin with dissolving PVA-CN in succinonitrile (NCCH₂CH₂CN) to form a mixture solution. This is followed by adding an initiator into the mixture solution. For instance, LiPF₆ can be added into the PVA-CN/SN mixture solution at a weight ratio (selected from the preferred range from 20:1 to 2:1) to form a precursor solution. Then, particles of a selected anode active material (with or without an elastic polymer coating pre-deposited on particle surfaces) and an optional conductive reinforcement material are introduced into the mixture solution to form a slurry. The slurry may then be slot-die coated or comma-coated onto a current collector surface to form a wet and reactive layer containing a reacting mass, PVA-CN/LiPF₆. This coating layer can then be heated at a temperature (e.g. from 75 to 100° C.) for 2 to 8 hours to obtain high-elasticity polymer-bonded anode active material particles. The conductive reinforcement materials (e.g. CNTs and graphene sheets) are dispersed in the network polymer of lightly crosslinked chains. During this process, cationic polymerization and cross-linking of cyano groups on the PVA-CN may be initiated by PF₅, which is derived from the thermal decomposition of LiPF₆ at such an elevated temperature.

It is essential for these materials to form a lightly cross-linked network of polymer chains that chemically bond to the active material particles. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc=ρRT/Ge, where Ge is the equilibrium modulus as determined by a temperature sweep in dynamic mechanical analysis, p is the physical density, R is the universal gas constant in J/mol*K and T is absolute temperature in K. Once Ge and ρ are determined experimentally, then Mc and the cross-link density can be calculated.

The magnitude of Mc may be normalized by dividing the Mc value by the molecular weight of the characteristic repeat unit in the cross-link chain or chain linkage to obtain a number, Nc, which is the number of repeating units between two cross-link points. We have found that the elastic deformation strain correlates very well with Mc and Nc. The elasticity of a cross-linked polymer derives from a large number of repeating units (large Nc) between cross-links. The repeating units can assume a more relax conformation (e.g. random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory's Network Theory. The Flory-Rehner Equation can be useful in the determination of cross-linking.

The high-elasticity polymer may contain a simultaneous interpenetrating network (SIN) polymer, wherein two cross-linking chains intertwine with each other, or a semi-interpenetrating network polymer (semi-IPN), which contains a cross-linked polymer and a linear polymer. An example of semi-IPN is an UV-curable/polymerizable trivalent/monovalent acrylate mixture, which is composed of ethoxylated trimethylolpropane triacrylate (ETPTA) and ethylene glycol methyl ether acrylate (EGMEA) oligomers. The ETPTA, bearing trivalent vinyl groups, is a photo (UV)-crosslinkable monomer, capable of forming a network of cross-linked chains. The EGMEA, bearing monovalent vinyl groups, is also UV-polymerizable, leading to a linear polymer with a high flexibility due to the presence of the oligomer ethylene oxide units. When the degree of cross-linking of ETPTA is moderate or low, the resulting ETPTA/EGMEA semi-IPN polymer provides good mechanical flexibility or elasticity and reasonable mechanical strength. The lithium-ion conductivity of this polymer is in the range from 10⁻⁴ to 5×10⁻³ S/cm.

The aforementioned high-elasticity polymers may be used alone to chemically bond the anode active material particles (as a binder polymer) or to encapsulate electrode active material particles (as a coating polymer). Alternatively, the high-elasticity polymer can be mixed with a broad array of elastomers, electrically conducting polymers, lithium ion-conducting materials, and/or strengthening materials (e.g. carbon nanotube, carbon nano-fiber, or graphene sheets).

A broad array of elastomers can be part of a high-elasticity polymer to bond the anode active material particles together in an anode layer. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually consists of two types of domains, soft domains and hard ones. Entangled linear backbone chains consisting of poly(tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

In some embodiments, a high-elasticity polymer can form a polymer matrix composite containing a lithium ion-conducting additive dispersed in the high-elasticity polymer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4.

In some embodiments, the high-elasticity polymer can be mixed with a lithium ion-conducting additive, which contains a lithium salt selected lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃ SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

The high-elasticity polymer may form a mixture, blend, or semi-interpenetrating network with an electron-conducting polymer selected from polyaniline, polypyrrole, polythiophene, polyfuran, a bi-cyclic polymer, derivatives thereof (e.g. sulfonated versions), or a combination thereof.

In some embodiments, the high-elasticity polymer may form a mixture or with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a derivative thereof (e.g. sulfonated versions), or a combination thereof.

Unsaturated rubbers that can be part of a high-elasticity polymer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR),

Some elastomers are saturated rubbers that cannot be cured by sulfur vulcanization; they are made into a rubbery or elastomeric material via different means: e.g. by having a copolymer domain that holds other linear chains together.

Polyurethane and its copolymers (e.g. urea-urethane copolymer) are particularly useful elastomeric binder materials for bonding anode active material particles. The starting materials for a polyurethane, a polyol and a diisocyanate, are typically in a liquid state to begin with and hence are particularly convenient materials to combine with the anode active material particles and the conductive reinforcement materials to form a slurry.

The binder formulation typically requires the high-elasticity polymer or its precursor (monomer or oligomer) to be dissolvable in a solvent. Fortunately, all the high-elasticity polymers or their precursors used herein are soluble in some common solvents or themselves are in a liquid state before polymerization begins. The un-cured polymer or its precursor can be readily dissolved in a common organic solvent to form a solution. This solution can then be used to bond solid particles via several of the binder application methods to be discussed in what follows. Upon contact with active material particles, the precursor is then polymerized and cross-linked.

The first method includes dispersing the anode or cathode active materials particles into the polymer precursor solution to form a slurry, which is then coated onto a surface of a current collector (e.g. Cu foil). The liquid medium of the coated slurry is then removed to form a dried layer containing the active material particles and conductive additive particles each partially coated with the polymer pre-cursor (monomer or oligomer). This procedure is essentially identical or very similar to the current slurry coating process commonly used in lithium-ion battery. Hence, there is no need to change the production equipment or facility. This dried layer is exposed to heat and/or UV light to initiate the polymerization and cross-linking reactions that harden the binder resin and bonds the solid particles together. Preferably, the amount of polymer is selected in such a manner that the binder resin only covers less than 50% (preferably <20%) of the exterior surface of an active material particle.

For particle coating or encapsulation, one may also use a modified pan coating process that involves tumbling the active material particles in a pan or a similar device while the precursor solution is applied slowly until a desired amount of contact between the polymer precursor and solid active material particles is achieved. The concentration of the monomer/oligomer in the solution is selected to ensure enough polymer to help bond the active particles together, but not to cover the entire exterior surface of active material particles. Preferably, a majority of the exterior surface of an active material particle is not covered by the polymer.

Solution spraying also may be used to apply a binder resin to surfaces of active material particles supported by a solid substrate. The polymer precursor solution, along with particles of active material and conductive reinforcements and/or additive, may be spray-coated onto a surface of a current collector. Upon removal of the liquid solvent, the dried mass is subjected to thermally or UV-induced polymerization and cross-linking.

The present disclosure also provides a method of manufacturing a lithium battery anode or cathode, the method comprising providing an anode or cathode active material layer and an optional anode current collector to support the anode or cathode active material layer, wherein the operation of providing the anode or cathode active material layer includes bonding multiple particles of an anode or cathode active material (that are pre-coated with a high-elasticity and lithium ion-conducting coating polymer) and an optional conductive additive together to form the layer by a binder resin containing a high-elasticity polymer composite comprising a high-elasticity polymer matrix and 0%-50% (preferably 0.01%-30% and further preferably 0.1%-15%) by weight of a conductive reinforcement material dispersed in the high-elasticity polymer matrix, wherein the high-elasticity polymer comprises a cross-linked network of polymer chains and the high-elasticity polymer has a recoverable tensile strain from 5% to 700% when measured without the conductive reinforcement dispersed in the polymer.

During the formation procedure of the anode or cathode electrode or anode or cathode layer, one may choose to introduce a blowing agent (foaming agent) into the electrode layer to produce pores in a controlled manner. In certain embodiments, there are some conductive reinforcement materials being dispersed in the elastic polymer as a matrix to improve the electrical conductivity and structural integrity of the anode electrode or layer, preferably having some built-in porosity.

In certain other embodiments, there is no conductive reinforcement (0%) dispersed in the elastic polymer binder material, but there are some built-in pores to accommodate volume expansion of the anode active material particles during the charging step of the lithium battery. A sufficient amount of pores in the anode can significantly increase the cycle life of a lithium-ion battery featuring such an anode electrode.

In some preferred embodiments, pores can be introduced into an electrode by adding a blowing agent into the electrode layer structure being formed on a current collector surface. One may choose to use a chemical foaming agent and/or a physical foaming agent.

Chemical foaming agents (CFAs) can be organic or inorganic compounds that release gasses upon thermal decomposition. CFAs are typically used to obtain medium- to high-density foams, and are often used in conjunction with physical blowing agents to obtain low-density foams. CFAs can be categorized as either endothermic or exothermic, which refers to the type of decomposition they undergo. Endothermic types absorb energy and typically release carbon dioxide and moisture upon decomposition, while the exothermic types release energy and usually generate nitrogen when decomposed. The overall gas yield and pressure of gas released by exothermic foaming agents is often higher than that of endothermic types. Endothermic CFAs are generally known to decompose in the range from 130 to 230° C. (266-446° F.), while some of the more common exothermic foaming agents decompose around 200° C. (392° F.). However, the decomposition range of most exothermic CFAs can be reduced by addition of certain compounds. The activation (decomposition) temperatures of CFAs fall into the range of our heat treatment temperatures. Examples of suitable chemical blowing agents include sodium bi-carbonate (baking soda), hydrazine, hydrazide, azodicarbonamide (exothermic chemical blowing agents), nitroso compounds (e.g. N, N-Dinitroso pentamethylene tetramine), hydrazine derivatives (e.g. 4,4′-Oxybis (benzenesulfonyl hydrazide) and Hydrazo dicarbonamide), and hydrogen carbonate (e.g. Sodium hydrogen carbonate). These are all commercially available in plastics industry.

In the production of foamed plastics, physical blowing agents are metered into the plastic melt during foam extrusion or injection molded foaming, or supplied to one of the precursor materials during polyurethane foaming. It has not been previously known that a physical blowing agent can be used to create pores in an electrode for a lithium-ion battery. We have surprisingly observed that a physical blowing agent (e.g. CO₂ or N₂) can be injected into the stream of elastic polymer curing or polymerization suspension prior to being coated or cast onto the supporting substrate (e.g. Cu foil). This would result in a foamed structure even when the liquid medium is removed.

Technically feasible blowing agents include Carbon dioxide (CO₂), Nitrogen (N₂), Isobutane (C₄H₁₀), Cyclopentane (C₅H₁₀), Isopentane (C₅H₁₂), CFC-11 (CFCI₃), HCFC-22 (CHF₂CI), HCFC-142b (CF₂CICH₃), and HCFC-134a (CH₂FCF₃). However, in selecting a blowing agent, environmental safety is a major factor to consider. The Montreal Protocol and its influence on consequential agreements pose a great challenge for the producers of foam. Despite the effective properties and easy handling of the formerly applied chlorofluorocarbons, there was a worldwide agreement to ban these because of their ozone depletion potential (ODP). Partially halogenated chlorofluorocarbons are also not environmentally safe and therefore already forbidden in many countries. The alternatives are hydrocarbons, such as isobutane and pentane, and the gases such as CO₂ and nitrogen.

Except for those regulated substances, all the blowing agents recited above have been tested in our experiments. For both physical blowing agents and chemical blowing agents, the blowing agent amount introduced into the suspension is defined as a blowing agent-to-HA material weight ratio, which is typically from 0/1.0 to 1.0/1.0.

### Example 1: Anode Layers Containing High-Elasticity Polymer-Bonded Cobalt Oxide (Co₃O₄) Anode Particulates

An appropriate amount of inorganic salts Co(NO₃)₂.6H₂O and ammonia solution (NH₃—H₂O, 25 wt. %) were mixed together. The resulting suspension was stirred for several hours under an argon flow to ensure a complete reaction. The obtained Co(OH)₂ precursor suspension was calcined at 450° C. in air for 2 h to form particles of the layered Co₃O₄. Portion of the Co₃O₄ particles was then made into an anode active material layer using an ETPTA-based high-elasticity polymer binder (with or without graphitic nano-fibers, GNFs, as a conductive reinforcement dispersed in the polymer) according to the following procedure:

The ethoxylated trimethylopropane triacrylate monomer (ETPTA, Mw=428, Sigma-Aldrich) was dissolved in a solvent mixture of ethylene carbonate (EC)/diethyl carbonate (DEC), at a weight-based composition ratios of the ETPTA/solvent of 3/97 (w/w). Subsequently, benzoyl peroxide (BPO, 1.0 wt. % relative to the ETPTA content) was added as a radical initiator to allow for the subsequent thermal crosslinking reaction to be initiated after the formation of an anode layer.

The anode active material particles (Co₃O₄ particles) were coated with a layer of graphene sheets by using spray-drying of an alcohol mixture of graphene oxide sheets and Co₃O₄ particles. The resulting graphene-coated Co₃O₄ particles and some GNFs (as a conductive reinforcement) were dispersed in the ETPTA monomer/solvent/initiator solution to form a slurry, which was spray-coated onto a Cu foil surface to form a layer of mixture of ETPTA monomer/initiator, GNFs, and graphene-coated Co₃O₄ particles. This layer was then thermally cured at 60° C. for 30 min to obtain an anode active material layer composed of graphene-wrapped Co₃O₄ particles that are bonded together by a high-elasticity polymer-based binder resin containing GNFs dispersed therein.

On a separate basis, some amount of the ETPTA monomer/solvent/initiator solution was cast onto a glass surface to form a wet film, which was thermally dried and then cured at 60° C. for 30 min to form a film of cross-linked polymer. In this experiment, the BPO/ETPTA weight ratio was varied from 0.1% to 4% to vary the degree of cross-linking in several different polymer films. Some of the cured polymer samples were subjected to dynamic mechanical testing to obtain the equilibrium dynamic modulus, Ge, for the determination of the number average molecular weight between two cross-link points (Mc) and the corresponding number of repeat units (Nc), as a means of characterizing the degree of cross-linking.

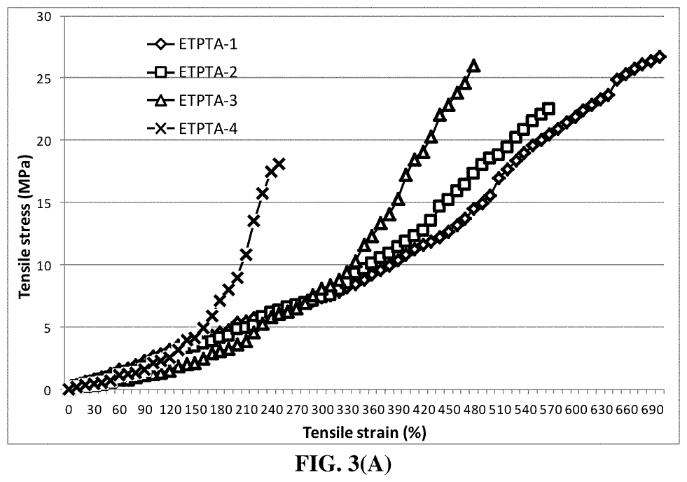

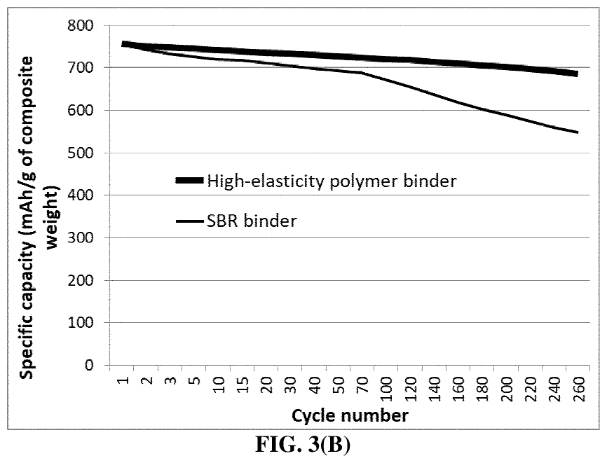

Several tensile testing specimens were cut from each cross-link film and tested with a universal testing machine. The representative tensile stress-strain curves of four BPO-initiated cross-linked ETPTA polymers are shown in FIG. 3(A), which indicate that this series of network polymers have an elastic deformation from approximately 230% to 700%. These values are for neat polymers without any additive. The addition of up to 30% by weight of a lithium salt typically reduces this elasticity down to a reversible tensile strain from 10% to 100%.

For electrochemical testing, a comparative electrode using a conventional binder resin is also prepared. The working electrodes were prepared by mixing 85 wt. % active material (graphene-coated Co₃O₄, particles, 7 wt. % GNFs, and 8 wt. % polyvinylidene fluoride (PVDF) binder dissolved in N-methyl-2-pyrrolidinoe (NMP) to form a slurry of 5 wt. % total solid content. After coating the slurries on Cu foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The CV measurements were carried out using a CH-6 electrochemical workstation at a scanning rate of 1 mV/s.

The electrochemical performance of the cell featuring high-elasticity polymer binder and that containing PVDF binder were evaluated by galvanostatic charge/discharge cycling at a current density of 50 mA/g, using a LAND electrochemical workstation. As summarized in FIG. 3(B), the first-cycle lithium insertion capacity values are 756 mAh/g (conventional SBR binder) and 757 mAh/g (BPO-initiated ETPTA polymer-based binder), respectively, which are higher than the theoretical values of graphite (372 mAh/g). Both cells exhibit some first-cycle irreversibility. The initial capacity loss might have resulted from the incomplete conversion reaction and partially irreversible lithium loss due to the formation of solid electrolyte interface (SET) layers.

As the number of cycles increases, the specific capacity of the SBR-bonded Co₃O₄ electrode drops precipitously. Compared with its initial capacity value of approximately 756 mAh/g, its capacity suffers a 20% loss after 175 cycles and a 27.51% loss after 260 cycles. In contrast, the presently invented high-elasticity polymer binder provides the battery cell with a significantly more stable and high specific capacity for a large number of cycles, experiencing a capacity loss of 9.51% after 260 cycles. These data have clearly demonstrated the surprising and superior performance of the presently invented high-elasticity polymer binder.

It may be noted that the number of charge-discharge cycles at which the specific capacity decays to 80% of its initial value is commonly defined as the useful cycle life of a lithium-ion battery.

The high-elasticity polymer binder appears to be capable of reversibly deforming without breakage when the anode active material particles expand and shrink. The polymer also remains chemically bonded to the anode active material particles when these particles expand or shrink. In contrast, the SBR binder is broken or detached from some of the active material particles. These were observed by using SEM to examine the surfaces of the electrodes recovered from the battery cells after some numbers of charge-discharge cycles.

### Example 2: High-Elasticity Polymer Binder-Bonded Tin Oxide Particulates

Tin oxide (SnO₂) nano particles were obtained by the controlled hydrolysis of SnCl₄.5H₂O with NaOH using the following procedure: SnCl₄.5H₂O (0.95 g, 2.7 m-mol) and NaOH (0.212 g, 5.3 m-mol) were dissolved in 50 mL of distilled water each. The NaOH solution was added drop-wise under vigorous stirring to the tin chloride solution at a rate of 1 mL/min. This solution was homogenized by sonication for 5 min. Subsequently, the resulting hydrosol was reacted with H₂SO₄. To this mixed solution, few drops of 0.1 M of H₂SO₄ were added to flocculate the product. The precipitated solid was collected by centrifugation, washed with water and ethanol, and dried in vacuum. The dried product was heat-treated at 400° C. for 2 h under Ar atmosphere.

The high-elasticity polymer for binding SnO₂ nano particles was based on cationic polymerization and cross-linking of the cyanoethyl polyvinyl alcohol (PVA-CN) in succinonitrile (SN). The procedure began with dissolving PVA-CN in succinonitrile to form a mixture solution. This step was followed by adding an initiator into the solution. For the purpose of incorporating some lithium species into the high elasticity polymer, we chose to use LiPF₆ as an initiator. The ratio between LiPF₆ and the PVA-CN/SN mixture solution was varied from 1/20 to 1/2 by weight to form a series of precursor solutions. Subsequently, particles of a selected anode active material (SnO₂ and graphene-embraced SnO₂ particles) and graphene oxide sheets (as a conductive reinforcement) were introduced into these solutions to form a series of slurries. The slurries were then separately coated onto a Cu foil surface to produce an anode active material layer. The layer was then heated at a temperature from 75 to 100° C. for 2 to 8 hours to obtain a layer of high-elasticity polymer-bonded anode active material particles.

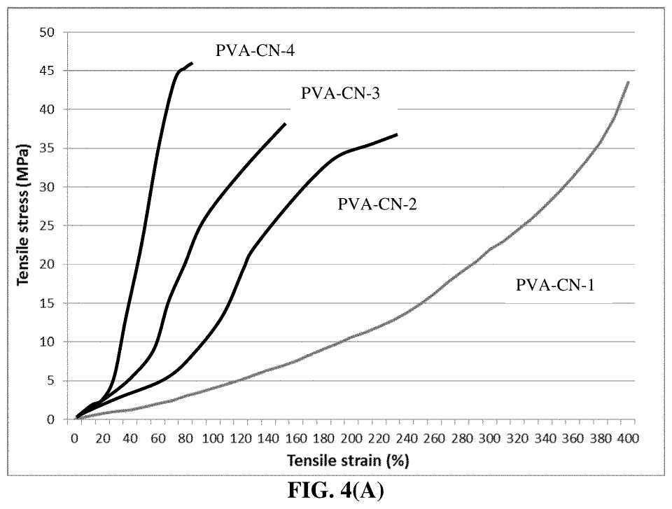

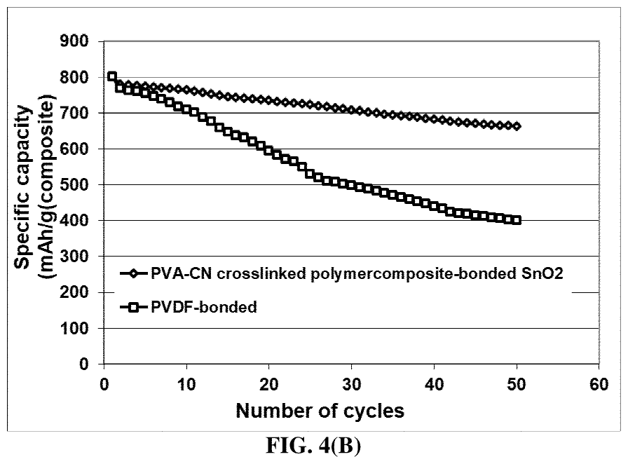

Additionally, the reacting mass, PVA-CN/LiPF₆, was cast onto a glass surface to form several films which were polymerized and cross-linked to obtain cross-linked polymers having different degrees of cross-linking. Tensile testing was also conducted on these films and some testing results are summarized in FIG. 4(a). This series of cross-linked polymers can be elastically stretched up to approximately 80% (higher degree of cross-linking) to 400% (lower degree of cross-linking).

The battery cells from the high-elasticity polymer-bonded particles (nano-scaled SnO₂ particles) and PVDF-bonded SnO₂ particles were prepared using a procedure described in Example 1. FIG. 4(B) shows that the anode prepared according to the presently invented high-elasticity polymer composite binder approach offers a significantly more stable and higher reversible capacity compared to the PVDF-bonded SnO₂ particle-based anode. The high-elasticity polymer composite is more capable of holding the anode active material particles together, significantly improving the structural integrity of the anode electrode.

Similar procedures were used to produce cathodes that contain well-known NCM, NCA, and LFP particles as the cathode active materials.

### Example 3: Tin (Sn) Nano Particles Bonded by a PETEA-Based High-Elasticity Polymer Composite

For serving as a resin binder to bond Sn nano particles together, pentaerythritol tetraacrylate (PETEA), Formula 3, was used as a monomer:

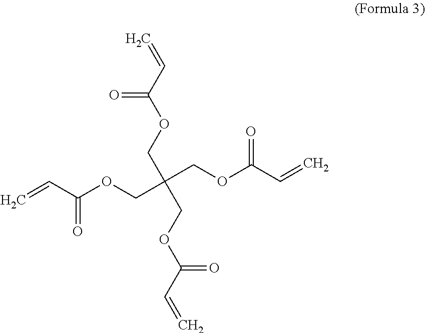 [SMILES: C=CC(=O)OCC(COC(=O)C=C)(COC(=O)C=C)COC(=O)C=C]

The precursor solution was composed of 1.5 wt. % PETEA (C₁₇H₂₀O₈) monomer and 0.1 wt. % azodiisobutyronitrile (AIBN, C₈H₁₂N₄) initiator dissolved in a solvent mixture of 1,2-dioxolane (DOL)/dimethoxymethane (DME)(1:1 by volume). Nano particles (76 nm in diameter) of Sn and expanded graphite flakes (graphite-to-Sn ratio=10/90) were added into the precursor solution, which was coated onto a Cu foil. The PETEA/AIBN precursor solution was polymerized and cured at 70° C. for half an hour to obtain an anode layer.

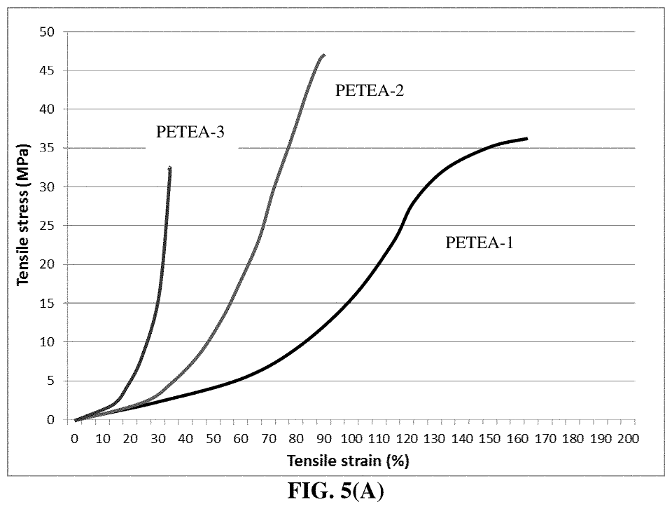

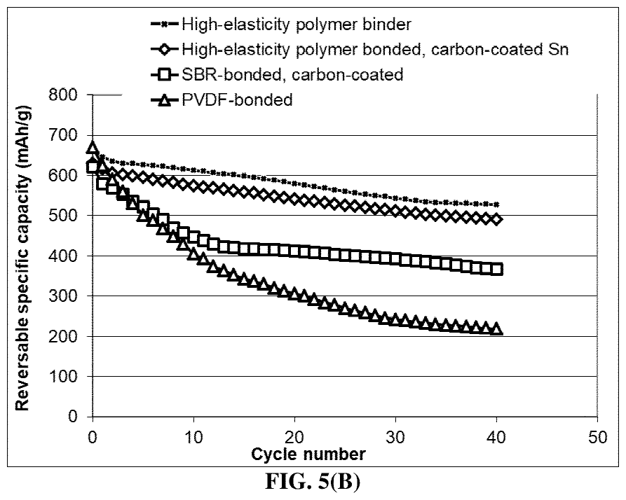

The reacting mass, PETEA/AIBN (without Sn particles and conductive reinforcement), was cast onto a glass surface to form several films which were polymerized and cured to obtain cross-linked polymers having different degrees of cross-linking. Tensile testing was also conducted on these films and some testing results are summarized in FIG. 5(A). This series of cross-linked polymers can be elastically stretched up to approximately 25% (higher degree of cross-linking) or to 80% (lower degree of cross-linking)

For comparison, some amount of Sn nano particles was bonded by SBR binder to make an anode. Shown in FIG. 5(B) are the discharge capacity curves of four coin cells having four different types of Sn-based anode layers: (1) high-elasticity PETEA polymer composite binder-bonded, carbon-coated Sn particles, (2) high-elasticity PETEA polymer composite binder-bonded Sn particles; (3) SBR rubber-bonded, carbon-coated Sn particles; and (d) PVDF-bonded Sn particles. These results have clearly demonstrated that the high-elasticity polymer binder strategy provides excellent protection against capacity decay of a lithium-ion battery featuring a high-capacity anode active material (having either encapsulated by carbon or non-encapsulated particles). Carbon encapsulation alone is not effective in providing the necessary protection against capacity decay.

The high-elasticity polymer binder appears to be capable of reversibly deforming without breakage when the anode active material particles expand and shrink. The polymer also remains chemically bonded to the anode active material particles when these particles expand or shrink. In contrast, both SBR and PVDF, the two conventional binder resins, are broken or detached from some of the active material particles. These were observed by using SEM to examine the surfaces of the electrodes recovered from the battery cells after some numbers of charge-discharge cycles.

### Example 4: Si Nanowire-Based Particulates Bonded by a High-Elasticity Polymer Composite

Si nano particles and Si nanowires Si nano particles are available from Angstron Energy Co. (Dayton, Ohio). Si nanowires, mixtures of Si and carbon, and their graphene sheets-embraced versions, respectively, were mixed with particles of acetylene black (a conductive additive) and formed into an active material layer using the instant polymers as a binder resin (semi-interpenetrating network polymer of ETPTA/EGMEA and the cross-linked BPO/ETPTA polymer, as in Example 1).

For bonding various anode particles together by the ETPTA semi-IPN polymer, the ETPTA (Mw=428 g/mol, trivalent acrylate monomer), EGMEA (Mw=482 g/mol, monovalent acrylate oligomer), and 2-hydroxy-2-methyl-1-phenyl-1-propanone (HMPP, a photoinitiator) were dissolved in a solvent (propylene carbonate, PC) to form a solution. The weight ratio between HMPP and the ETPTA/EGMEA mixture was varied from 0.2% to 2%. The ETPTA/EGMEA proportion in the solution was varied from 1% to 5% to generate different encapsulation layer thicknesses. The ETPTA/EGMEA ratio in the acrylate mixture was varied from 10/0 to 1/9.

Si materials were added into one active material mass (ETPTA/EGMEA/HMPP) to form suspension A. Graphitic nano-fibers (GNFs) and expanded graphite flakes (EPG) were added into another separate active material mass to form suspension B and properly stirred to ensure thorough dispersion of the conductive reinforcement material in the reactive mass.

Ultrasonic spraying was used to deposit alternate layers of suspension A and suspension B to produce the electrode over a sheet of Cu foil. The active material layer containing ETPTA/EGMEA/HMPP was then exposed to UV irradiation for 40 s. The UV polymerization or cross-linking was conducted using a Hg UV lamp (100 W), having a radiation peak intensity of approximately 2000 mW/cm² on the surfaces of the electrodes.

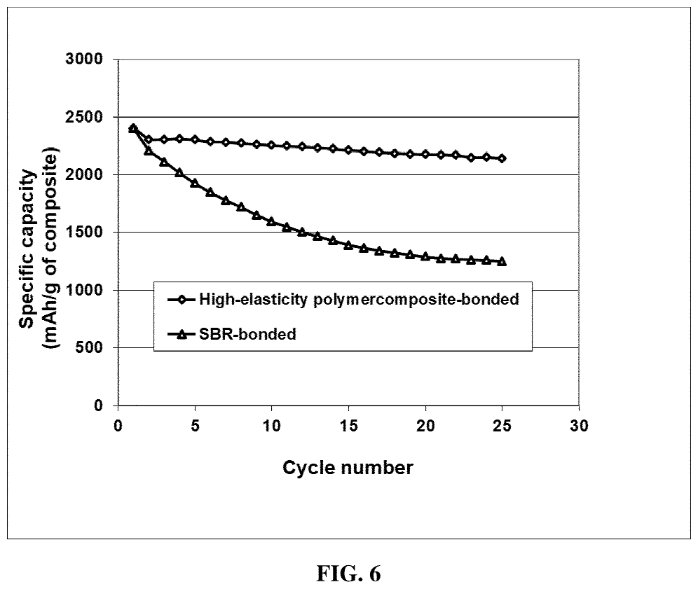

The above procedure was conducted to produce electrode layers that were bonded by a cross-linked ETPTA/EGMEA polymer. For comparison purposes, electrodes containing Si nanowires bonded by SBR binder were also prepared and implemented in separate lithium-ion cells. The cycling behaviors of these 2 cells are shown in FIG. 6, which indicates that high-elasticity polymer composite binder-bonded Si nanowires provide significantly more stable cycling response.

### Example 5: Production of Anode Layers of PEDOT:PS/CNT-Bonded SiO Particles

Poly(3,4-ethylenedioxythiophene):polystyrene sulfonate (PEDOT:PSS) is a polymer mixture of two ionomers. One component is made up of sodium polystyrene sulfonate, which is a sulfonated polystyrene. Part of the sulfonyl groups are deprotonated and carry a negative charge. The other component poly(3,4-ethylenedioxythiophene) or PEDOT is a conjugated polymer, polythiophene, which carries positive charges. Together the two charged polymers form a macromolecular salt. The PEDOT/PSS is soluble in water.

Desired amounts of the graphene sheets and carbon-coated SiO particles (supplied from Angstron Energy Co., Dayton, Ohio) were then dispersed in a PEDOT/PSS-water solution to form a slurry (10% by wt. solid content), which was then coated onto a Cu foil using comma coating to form an anode layer comprising SiO particles bonded by a binder of PEDOT/PSS. On a separate basis, carbon nanotubes (CNTs) were added into a similar slurry to make a composite electrode comprising SiO particles bonded by a binder of CNT-reinforced PEDOT/PSS.

### Example 6: Preparation of Reactive Pyrrole-Based Conductive Polymer Network Binders and Anode Electrodes

Polypyrrole networks (cross-linked PPy or PPy hydrogels) were prepared via a two-reactant, one-pot process. Pyrrole (>97% purity) was dissolved in a solvent of water/ethanol (1:1 by weight) to achieve the first reactant having a concentration of 0.209 mol/L.

Then, as the second reactant, aqueous solutions of ferric nitrate (Fe(NO₃)₃.9H₂O) and ferric sulfate, respectively, were made at concentrations of 0.5 mol/L. Subsequently, polymerization of the network gels was carried out in an ice bath at 0° C., by mixing volumes of the two reactants at 1:1 molar ratios of pyrrole:ferric salt, to create a reacting mixture with a total of 4 mL. Particles of an anode active material (e.g. thin polyurethane-coated nano, sub-micron, or micron Si particles) and a conductive reinforcement material (CNTs and/or graphene sheets) can be dispersed in this reacting mixture. After rigorously stirring for 1-3 minutes, the slurry mass was cast or coated over a Cu foil surface to form a reacting electrode layer, and polymerization and gelation began after 5 minutes. A pyrrole:ferric salt molar ratio of 1:1, which is stoichiometrically deficient of ferric salt, leads to secondary growth (cross-linking) of the polypyrrole network, which could continue for several days at room temperature to produce cohesive hydrogels of high elasticity upon removal of the liquid phase (water and ethanol).

### Example 7: Production of Conducting Polyaniline Network as a Binder

The precursor of a conducting network polymer, such as cross-linkable polyaniline and polypyrrole, may contain a monomer, an initiator or catalyst, a crosslinking or gelating agent, an oxidizer and/or dopant. As an example, 3.6 ml aqueous solution A, which contains 400 mM aniline monomer and 120 mM phytic acid, was added and mixed with 280 mg conductive reinforcements (e.g. graphene sheets and/or CNTs) and desired anode particles (Si, SiO, Ge, P, Sn, etc. pre-coated with a high-elasticity polymer). Subsequently, 1.2 ml solution B, containing 500 mM ammonium persulfate was added into the above mixture and subjected to bath sonication for 1 min. The resulting reactive suspension was coated onto a stainless steel foil surface to form an anode layer. In about 5-10 min, the solution changed color from brown to dark green and became viscous and gel-like, indicating in-situ polymerization of aniline monomer to form the PANi hydrogel. The resulting layer was further cured at 50° C. for 0.5-2 hours to obtain an anode of PANi network polymer/graphene-CNT composite bonded anode particles.

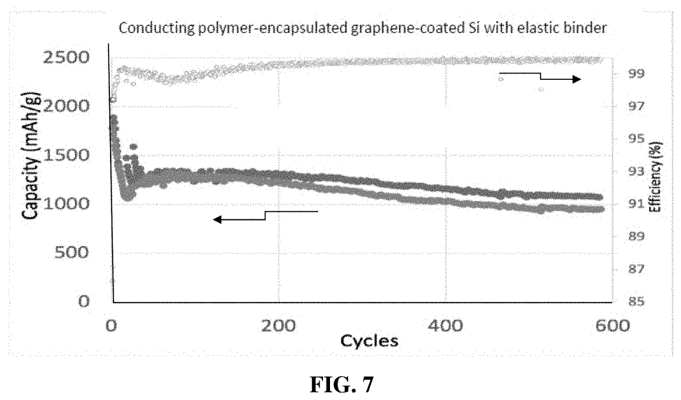

FIG. 7 shows the Coulombic efficiency and specific capacity data of two cells each comprising a porous anode comprising PANI-coated Si particles which are bonded by PANI network/graphene based binder resin. These cells show impressive cycling behaviors.

Similar procedures were used to produce cathodes that contain well-known layered compound LiCoO₂, spinel compound LiMn₂O₄, olivine compound LiMnPO₄, NCM, NCA, and LFP particles as the cathode active materials.

### Example 8: Effect of Lithium Ion-Conducting Additive in a High-Elasticity Polymer Binder

A wide variety of lithium ion-conducting additives were added to several different polymer matrix materials to prepare binder resin materials for maintaining structural integrity of electrodes. We have discovered that these polymer composite materials are suitable binder materials. Since the high-elasticity polymer can cover a significant portion of the active material particle surface, this polymer (with or without the lithium ion-conducting additive) preferably is capable of allowing lithium ions to readily diffuse through. Hence, the polymer preferably has a lithium ion conductivity at room temperature no less than 10⁻⁸ S/cm, preferably higher than 10⁻⁵ S/cm.

TABLE 2
Lithium ion conductivity of various high-elasticity polymer composite compositions
as a shell material for protecting anode active material particles.

| | Lithium-conducting | Elastomer | Li-ion conductivity |
|---|---|---|---|
| Sample No. | additive | (1-2 μm thick) | (S/cm) |
| E-1b | Li₂CO₃ + (CH₂OCO₂Li)₂ | 70-99% PVA-CN | 2.9 × 10⁻⁴ to 3.6 × 10⁻³ S/cm |
| E-2b | Li₂CO₃ + (CH₂OCO₂Li)₂ | 65-99% ETPTA | 6.4 × 10⁻⁴ to 2.3 × 10⁻³ S/cm |
| E-3b | Li₂CO₃ + (CH₂OCO₂Li)₂ | 65-99% ETPTA/EGMEA | 8.4 × 10⁻⁴ to 1.8 × 10⁻³ S/cm |
| D-4b | Li₂CO₃ + (CH₂OCO₂Li)₂ | 70-99% PETEA | 7.8 × 10⁻³ to 2.3 × 10⁻² S/cm |
| D-5b | Li₂CO₃ + (CH₂OCO₂Li)₂ | 75-99% PVA-CN | 8.9 × 10⁻⁴ to 5.5 × 10⁻³ S/cm |
| B1b | LiF + LiOH + Li₂C₂O₄ | 60-90% PVA-CN | 8.7 × 10⁻⁵ to 2.3 × 10⁻³ S/cm |
| B2b | LiF + HCOLi | 80-99% PVA-CN | 2.8 × 10⁻⁴ to 1.6 × 10⁻³ S/cm |
| B3b | LiOH | 70-99% PETEA | 4.8 × 10⁻³ to 1.2 × 10⁻² S/cm |
| B4b | Li₂CO₃ | 70-99% PETEA | 4.4 × 10⁻³ to 9.9 × 10⁻³ S/cm |
| B5b | Li₂C₂O₄ | 70-99% PETEA | 1.3 × 10⁻³ to 1.2 × 10⁻² S/cm |
| B6b | Li₂CO₃ + LiOH | 70-99% PETEA | 1.4 × 10⁻³ to 1.6 × 10⁻² S/cm |
| C1b | LiClO₄ | 70-99% PVA-CN | 4.5 × 10⁻⁴ to 2.4 × 10⁻³ S/cm |
| C2b | LiPF₆ | 70-99% PVA-CN | 3.4 × 10⁻⁴ to 7.2 × 10⁻³ S/cm |
| C3b | LiBF₄ | 70-99% PVA-CN | 1.1 × 10⁻⁴ to 1.8 × 10⁻³ S/cm |
| C4b | LiBOB + LiNO₃ | 70-99% PVA-CN | 2.2 × 10⁻⁴ to 4.3 × 10⁻³ S/cm |
| S1b | Sulfonated polyaniline | 85-99% ETPTA | 9.8 × 10⁻⁵ to 9.2 × 10⁻⁴ S/cm |
| S2b | Sulfonated SBR | 85-99% ETPTA | 1.2 × 10⁻⁴ to 1.0 × 10⁻³ S/cm |
| S3b | Sulfonated PVDF | 80-99% ETPTA/EGMEA | 3.5 × 10⁻⁴ to 2.1 × 10⁻⁴ S/cm |
| S4b | Polyethylene oxide | 80-99% ETPTA/EGMEA | 4.9 × 10⁻⁴ to 3.7 × 103⁴ S/cm |

### Example 9: Cycle Stability of Various Rechargeable Lithium Battery Cells

In lithium-ion battery industry, it is a common practice to define the cycle life of a battery as the number of charge-discharge cycles that the battery suffers 20% decay in capacity based on the initial capacity measured after the required electrochemical formation. Summarized in Table 3 below are the cycle life data of a broad array of batteries featuring presently invented electrodes containing anode active material particles bonded by different binder materials.

TABLE 3
Cycle life data of various lithium secondary (rechargeable) batteries.

| | | | Initial | |
|---|---|---|---|---|
| | | | capacity | Cycle life |
| Sample ID | Binder resins | Type & % of anode active material | (mAh/g) | (No. of cycles) |
| Si-1b | PVA-CN | 25% by wt. Si nano particles (80 nm) + | 1,120 | 1,150 |
| | | 67% graphite + 8% binder | | |
| Si-2b | SBR | 25% by wt. Si nano particles (80 nm) + | 1,119 | 155 |
| | | 67% graphite + 8% binder | | |
| SiNW-1b | SBR | 45% Si nano particles, pre-lithiated | 1,258 | 255 |
| SiNW-2b | PVA-CN + 50% | 45% Si nano particles, pre-ithiated | 1,760 | 1,250 |
| | ethylene oxide | | | |
| VO₂-1b | ETPTA | 90%-95%, VO₂ nano ribbon | 255 | 1,140 |
| VO₂-2b | PVDF | 90%-95%, VO₂ nano ribbon | 720 | 147 |
| SnO₂-2b | ETPTA/EGMEA + | 75% SnO₂ particles (3 μm initial size) | 740 | 1,280 |
| | 20% polyanniline | | | |
| SnO₂-2b | ETPTA/EGMEA | 75% SnO₂ particles (3 μm initial size) | 738 | 1,626 |
| Ge-1b | PETEA | 85% Ge + 8% graphite platelets + binder | 850 | 1,552 |
| Ge-2b | PVDF | 85% Ge + 8% graphite platelets + binder | 856 | 145 |

These data further confirm that the high-elasticity polymer binder strategy is surprisingly effective in alleviating the anode expansion/shrinkage-induced capacity decay problems.

We claim:

1. A porous anode or cathode electrode for a lithium battery, said porous electrode comprising multiple particles of an electrode active material, an optional conductive additive, and a polymer binder that bonds said particles and conductive additive together to form said electrode wherein said multiple particles have pores occupying a pore volume faction Vp and said electrode has pores, external to the multiple particles, occupying a volume faction Ve, wherein Ve and Vp are all based on the total electrode volume, not counting the volume of an electrode current collector, and the total pore volume fraction Vt=Vp+Ve is from 10% to 80% in such a manner that a volume expansion of the electrode in a battery cell during battery charge/discharge operations does not exceed 30%.

2. The porous electrode of claim 1, wherein said multiple particles comprise porous primary particles, porous secondary particles, or a combination of porous primary and secondary particles.

3. The porous electrode of claim 1, wherein the total pore volume fraction Vt is from 20% to 70% or the volume expansion of the electrode in a battery cell during battery charge/discharge operations does not exceed 10%.

4. The porous electrode of claim 1, wherein the multiple particles are coated with or encapsulated by a high-elasticity coating polymer having a recoverable tensile strain from 5% to 700%, when measured without the conductive additive dispersed in said coating polymer, and a lithium ion conductivity no less than 10⁻⁸ S/cm.

5. The porous electrode of claim 1, wherein the polymer binder comprises a high-elasticity polymer having a recoverable tensile strain from 5% to 700%, when measured without an additive dispersed in said polymer.

6. The porous electrode of claim 4, wherein the electrode further comprises a high-elasticity polymer binder having a recoverable tensile strain from 5% to 700% when measured without an additive dispersed in said binder polymer.

7. The porous electrode of claim 1, wherein the multiple particles are coated with or encapsulated by a high-elasticity coating polymer having a recoverable tensile strain from 5% to 700% or wherein the polymer binder comprises a high-elasticity binder polymer having a recoverable tensile strain from 5% to 700%, wherein the coating polymer and/or the binder polymer further comprises a 0.01%-50% by weight of a conductive reinforcement material dispersed in said coating polymer or said binder polymer or bonded by said binder polymer.

8. The porous electrode of claim 7, wherein said conductive reinforcement is selected from the group consisting of carbon nanotubes, graphene sheets, carbon nano-fibers, graphite nano-fibers, carbon fibers, graphite fibers, expanded graphite flakes, carbon black, acetylene black, carbon particles, graphite particles, metal nanowires or whiskers, and combinations thereof.

9. The porous electrode of claim 1, wherein the multiple particles are coated with or encapsulated by a high-elasticity coating polymer having a recoverable tensile strain from 5% to 700% or wherein the polymer binder comprises a high-elasticity binder polymer having a recoverable tensile strain from 5% to 700%, wherein said high-elasticity coating polymer or binder polymer contains a cross-linked network polymer chains.

10. The porous electrode of claim 9, wherein said cross-linked network polymer chains comprises an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

11. The porous electrode of claim 9, wherein said cross-linked network polymer chains comprises a polymer selected from nitrile-containing polyvinyl alcohol chains, cyanoresin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

12. The porous electrode of claim 9, wherein said cross-linked network polymer chains comprises chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulfide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

13. The porous electrode of claim 4, wherein said high-elasticity coating polymer further comprises a lithium-ion conducting material dispersed in said coating polymer.

14. The porous electrode of claim 13, wherein said lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4.

15. The porous electrode of claim 13, wherein said lithium ion-conducting additive is selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

16. The porous electrode of claim 13, wherein said lithium ion-conducting additive is selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

17. The porous anode electrode of claim 1, wherein said electrode active material is selected from the group consisting of: (a) silicon (Si), germanium (Ge), tin (Sn), lead (Pb), antimony (Sb), bismuth (Bi), phosphorus (P), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo₂O₄; (f) prelithiated versions thereof; (g) particles of Li, Li alloy, or surface-stabilized Li having at least 60% by weight of lithium element therein; (h) particles or fibers of carbon and graphite; and (i) combinations thereof.

18. The porous anode electrode of claim 17, wherein said anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

19. The porous cathode electrode of claim 1, wherein said electrode active material is selected from an inorganic material, an organic material, a polymeric material, or a combination thereof.

20. The porous cathode electrode of claim 19, wherein said inorganic material is selected from a metal oxide, metal phosphate, metal silicide, metal selenide, transition metal sulfide, sulfur, lithium polysulfide, selenium, lithium selenide, or a combination thereof.

21. The porous cathode electrode of claim 19, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

22. The porous cathode electrode of claim 19, wherein said inorganic material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof.

23. The porous cathode electrode of claim 19, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

24. The porous cathode electrode of claim 19, wherein said inorganic material is selected from a transition metal dichalcogenide, a transition metal trichalcogenide, or a combination thereof.

25. The porous cathode electrode of claim 19, wherein said inorganic material is selected from TiS₂, TaS₂, MoS₂, NbSe₃, MnO₂, CoO₂, an iron oxide, a vanadium oxide, or a combination thereof.

26. The porous cathode electrode of claim 20, wherein said metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

27. The porous cathode electrode of claim 20, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

28. The porous cathode electrode of claim 19, wherein said inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

29. The porous anode or cathode electrode of claim 1, wherein one or a plurality of said particles is coated with a layer of carbon, graphene, or a combination thereof.

30. The porous anode or cathode electrode of claim 1, wherein said conductive additive comprises a carbon or graphite materials selected from the group consisting of carbon nanotubes, graphene sheets, carbon nano-fibers, graphite nano-fibers, carbon fibers, graphite fibers, expanded graphite flakes, carbon black, acetylene black, carbon particles, graphite particles, metal nanowires or whiskers, and combinations thereof.

31. The anode active material layer of claim 1, wherein said electrode particles comprise anode particles that are pre-intercalated or pre-doped with lithium ions to form a prelithiated anode active material having an amount of lithium from 0.1% to 54.7% by weight of said prelithiated anode active material.

32. A lithium battery comprising the anode or cathode electrode of claim 1.

33. The lithium battery of claim 32, which is a lithium-ion battery, lithium metal battery, lithium-sulfur battery, lithium-selenium battery, or lithium-air battery.

34. A method of manufacturing a lithium battery anode or cathode of claim 1, said method comprising:
(a) encapsulating said multiple particles (primary particles) of an anode or cathode active material with a high-elasticity coating polymer to form multiple secondary particles having pores therein wherein said coating polymer has a recoverable tensile strain from 5% to 700%, when measured without an additive or reinforcement dispersed in said coating polymer, and a lithium ion conductivity no less than 10⁻⁸ S/cm; and
(b) a procedure of forming said electrode by (i) bonding multiple secondary particles and an optional conductive additive together through the use of a binder resin containing a high-elasticity binder polymer, wherein the high-elasticity binder polymer comprises a cross-linked network of polymer chains and the high-elasticity polymer has a recoverable tensile strain from 5% to 700% when measured without an additive or reinforcement dispersed in said binder polymer; and (ii) generating additional pores, external to said secondary particles, in said electrode; wherein said pores in the secondary particles occupy a pore volume fraction Vp and said additional pores occupy a pore volume fraction Ve based on the total electrode volume, not counting the volume of an electrode current collector, and the total pore volume fraction Vt=Vp+Ve is from 10% to 80% in such a manner that a volume expansion of the electrode in a battery cell during battery charge/discharge operations does not exceed 30%.

35. The method of claim 34, further the procedure of producing additional pores in the electrode comprises a step of using a foaming agent.
